(19) United States
(12) Patent Application Publication
(10) Pub. No.: US 2009/0106449 A1
(43) Pub. Date: Apr. 23, 2009

(54) METHOD AND APPARATUS FOR PROVIDING DYNAMIC ROUTE ADVERTISEMENT

(76) Inventors: Michael Satterlee, Clifton Park, NY (US); Ley-Hua Chin, Palatine, IL (US); Timothy Clark, Mount Prospect, IL (US); Michael Nelson, Indianapolis, IN (US); Neal Shackleton, Tierra Verde, FL (US)

Correspondence Address: AT&T CORP., ROOM 2A207, ONE AT&T WAY, BEDMINSTER, NJ, 07921, US

(21) Appl. No.: 11/875,520

(22) Filed: Oct. 19, 2007

(51) Int. Cl. G06F 15/173

(52) U.S. Cl. 709/238

(57) ABSTRACT

A method and apparatus for providing dynamic route advertisement based on IP-Sec security associations are disclosed. The method receives a notification for an establishment, a deletion or a modification of a security association for a sub-network. The method then adds or deletes a route for the sub-network based on the security association and dynamically advertises the added or deleted route to one or more peer devices. In one embodiment, the method also receives an advertisement for an added or deleted route from a peer device, identifies at least one IP-Sec client for receiving the advertisement, and establishes or deletes one or more security associations for the at least one identified IP-Sec client.

The present invention relates generally to communication networks and, more particularly, to a method and apparatus for providing dynamic route advertisement based on IP-Sec security associations on a packet network, e.g., an Internet Protocol (IP) network, Virtual Private Network (VPN), etc.

### BACKGROUND OF THE INVENTION

An enterprise customer may build a Virtual Private Network (VPN) by connecting multiple sites or users over a network from a network service provider. For example, an enterprise customer may build a VPN to enable employees, suppliers, etc. to access data and communicate among each other in a secure manner regardless of the users' physical location. The security is provided using Internet Protocol-Security (IP-Sec) protocol to authenticate or encrypt each packet.

The enterprise customer may extend the footprint of the VPN by using less expensive Small Office Home Office (SOHO) broadband access connections. However, a SOHO connection may support multiple sub-networks behind a single IP-Sec device. Hence, routes for sub-networks located behind the SOHO device need to be advertised into the VPN, and vice versa from the VPN to the SOHO device.

### SUMMARY OF THE INVENTION

In one embodiment, the present invention discloses a method and apparatus for providing dynamic route advertisement based on IP-SEC security associations. The method receives a notification for an establishment, a deletion or a modification of a security association for a sub-network. The method then adds or deletes a route for the sub-network based on the security association and dynamically advertises the added or deleted route to one or more peer devices.

In one embodiment, the method also receives an advertisement for an added or deleted route from a peer device, identifies at least one IP-Sec client for receiving the advertisement, and establishes or deletes one or more security associations for the at least one identified IP-Sec client.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with dynamic route advertisement based on IP-Sec security associations;

FIG. 3 illustrates a flowchart of a method for providing dynamic route advertisement based on IP-Sec security associations;

FIG. 4 illustrates a flowchart of a method for establishing or deleting one or more IP-Sec associations based on route advertisements; and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing dynamic route advertisement based on IP-Sec security associations on a packet network. Although the present invention is discussed below in the context of virtual private networks, the present invention is not so limited. Namely, the present invention can be applied for other Internet protocol based networks.

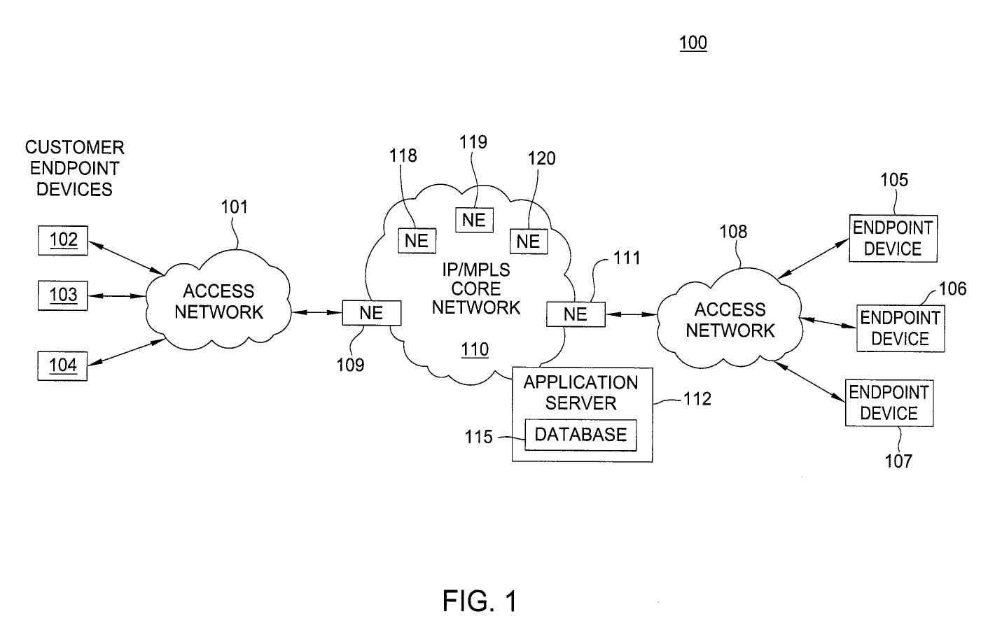

FIG. 1 is a block diagram depicting an exemplary packet network 100 related to the current invention. Exemplary packet networks include Internet protocol (IP) networks, Ethernet networks, and the like. An IP network is broadly defined as a network that uses Internet Protocol such as IPv4 or IPv6 to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, honeypot, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, and so on are depicted in FIG. 1, the communication system 100 may be expanded by including additional endpoint devices, access networks, border elements, etc. without altering the present invention.

The above IP network is described to provide an illustrative environment in which packets for voice and data services are transmitted on networks. In one embodiment, an enterprise customer may build a Virtual Private Network (VPN) by connecting multiple sites or users over a network from a network service provider. For example, an enterprise customer may build a VPN to enable users to access data and communicate securely regardless of their physical location. In one embodiment, the security is provided using Internet Protocol-Security (IP-Sec) protocol to authenticate or encrypt each packet.

The enterprise customer may further extend the footprint of the VPN by using less expensive Small Office Home Office (SOHO) broadband access connections. However, a SOHO connection may support multiple sub-networks behind a single IP-Sec device. Hence, routes for sub-networks located behind the SOHO device need to be advertised into the VPN, and similarly from the VPN to the SOHO device. The route advertisements for sub-networks located behind the SOHO device may be supported using a tunneling protocol, e.g., Generic Routing Encapsulation (GRE) protocol. However, GRE requires additional packet overhead and resources on both the SOHO and IP-Sec devices, and hence is costly.

In one embodiment, the present invention discloses a method and apparatus for dynamic route advertisement based on IP-Sec security associations on a packet network. In order to clearly describe the current invention, the following networking terminology are first provided:

A Virtual Private Network (VPN);

An Internet Protocol-Security (IP-Sec); and

A Security Association (SA).

A Virtual Private Network (VPN) refers to a network in which a set of customer locations communicate over a provider's network or the Internet in a private manner. The set of customer locations that may communicate with each other over the VPN are configured when the VPN is setup. That is, locations outside of the VPN are not allowed to intercept packets from the VPN or send packets over the VPN. Each VPN site has one or more Customer Edge (CE) routers attached to one or more Provider Edge (PE) routers. Each PE router attached to a CE router maintains a Virtual Route Forwarding (VRF) table for the VPN and forwards traffic among various VPN sites using the VRF table.

An Internet Protocol-Security (IP-Sec) refers to a security protocol for communicating over Internet protocol based networks. The security is provided by authenticating and/or encrypting each packet in a data stream. Network devices provide security using IP-Sec by establishing a security association for each flow, as described below.

A Security Association (SA) is the establishment of shared security information between two entities to support secure communication. For example, an SA may include cryptographic keys, initialization vectors or digital certificates that are used to encrypt and authenticate a particular flow. There are several standards based methods that may be used to establish security associations, e.g., using Internet Security Association and Key Management Protocol (ISAKMP) Phases 1, 1.5 or 2. An IP-Sec administrator may choose the encryption and authentication algorithms from a pre-determined list. It is important to note that a bi-directional traffic includes two flows, and hence is secured using a pair of security associations.

In order to select a type of security for an outgoing packet, IP-Sec uses a Security Parameter Index (SPI) to a security association database along with the destination IP address of the packet. The SPI and the destination address in a packet header uniquely identify a security association for that packet. For incoming packets, IP-Sec gathers decryption and/or verification keys from the security association database.

In one embodiment, the present invention provides dynamic route advertisement based on IP-Sec security associations on a packet network. The method enables a Provider Edge (PE) router to learn from a SOHO device when a security association is established, deleted, or modified for a sub-network located behind the SOHO device. The PE router may then add or delete routes for the sub-network based on the security associations learned from the SOHO device. The PE router also dynamically advertises the added or deleted routes to its peer devices using Border Gateway Protocol (BGP).

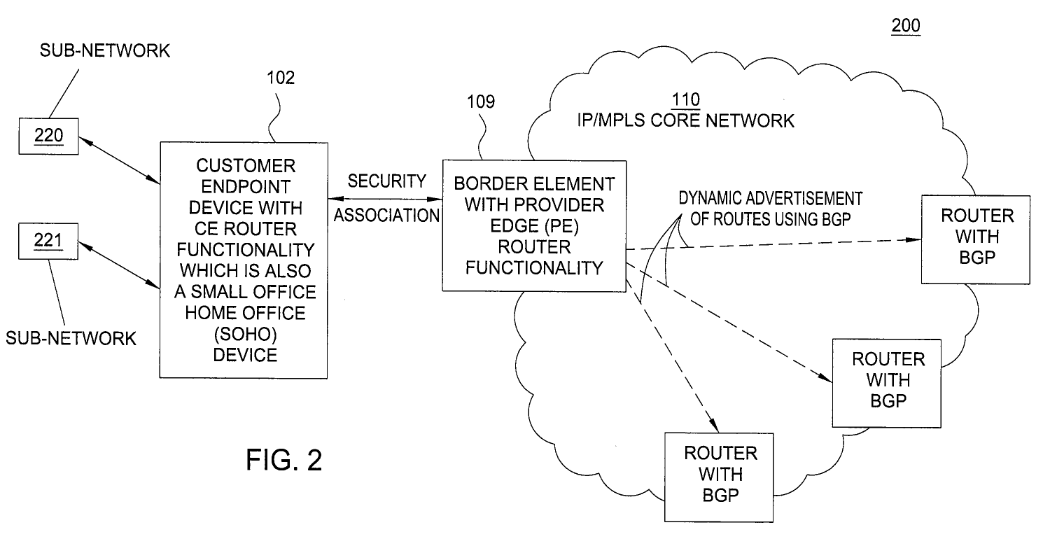

FIG. 2 provides an exemplary network 200 with dynamic route advertisement based on IP-Sec security associations. The exemplary network 200 comprises: sub-networks 220 and 221; Customer end point device with CE router functionality 102; and an IP/MPLS core network 110. The CE router 102 is connected to the IP/MPLS core network 110 through a border element with Provider Edge (PE) router functionality 109. The IP/MPLS core network 110 also includes various routers with Border Gateway Protocol (BGP) 211, 212 and 213.

In one embodiment, the CE router 102 also provides IP-Sec functionality and negotiates Security Associations (SA) with PE routers. The sub-networks 220 and 221 are located behind the CE router 102 which is also a SOHO device. The CE router 102 negotiates a security association for each of the sub-networks 220 (e.g., having a subnet address: 10.10.10.0) and 221 (e.g., having a subnet address: 10.10.11.0). Thus, the customer is able to extend the VPN footprint by using a Small Office Home Office (SOHO) connection for sub-networks 220 and 221. For example, the CE router 102 and the PE router 109 negotiate the SA (e.g., using IPSEC SA Add, or IPSEC SA Delete for the subnet addresses 10.10.10.0 and 10.10.11.0) for each of the sub-networks 220 and 221 using a standard protocol, e.g., an Internet Security Association and Key Management Protocol (ISAKMP).

The PE router 109 then adds or deletes routes for sub-networks 220 and 221 based on the security associations learned from the SOHO device, e.g., CE router 102. The PE router 109 also dynamically advertises the added or deleted routes to its peer devices, e.g., routers 211, 212 and 213, using BGP. For example, an IPSEC tunnel concentrator can be implemented within the BE 109 having an IPSEC interface portion for deducing the SAs associated with the sub-networks 220 and 221, and a BGP subsystem portion for establishing one or more sessions with BGP peers. As such, SAs associated with the sub-networks 220 and 221 obtained from the CE router 102 are converted as BGP update Add or BGP update withdraw for distribution to the BGP peers, and vice versa.

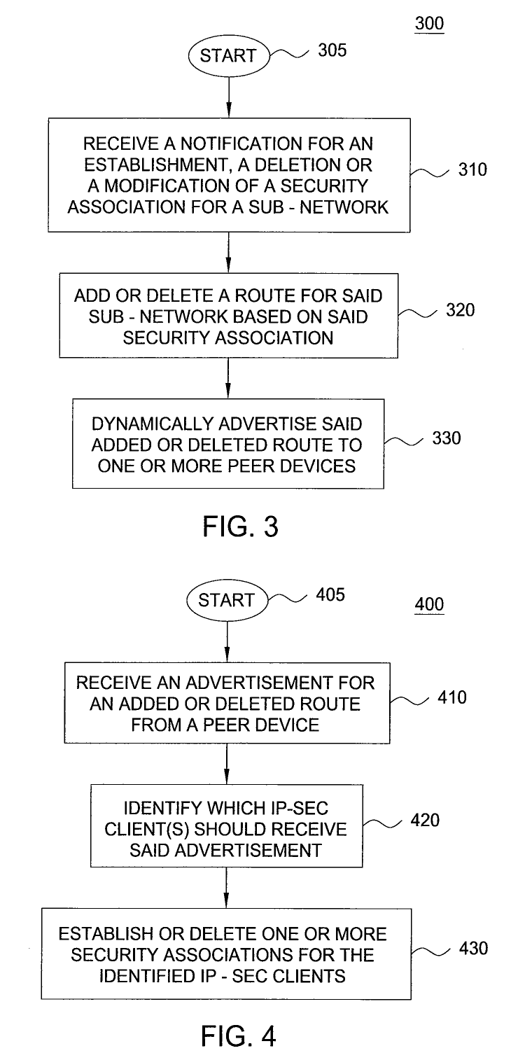

FIG. 3 illustrates a flowchart of a method 300 for providing dynamic route advertisement based on IP-Sec associations. Method 300 starts in step 305 and proceeds to step 310.

In step 310, method 300 receives a notification for an establishment, a deletion, or a modification of a security association for a sub-network. For example, a Provider Edge (PE) router learns from a SOHO device that a security association is established, deleted, or modified for a sub-network located behind the SOHO device.

In step 320, method 300 adds or deletes a route for the sub-network based on said security association. For example, if the PE device and the SOHO device negotiated a security association for a sub-network located behind the SOHO device, then the method may perform an “add route” command such that the route to the sub-network is added into the BGP system of the PE device.

In step 330, method 300 dynamically advertises the added or deleted route to one or more peer devices. For example, if a route is added, the method may send a BGP update to add the route. In another example, if a route is deleted, e.g., when an Ethernet cable for the sub-network is disconnected, the method may send a BGP update to withdraw the route. The method then proceeds to step 310 to continue receiving notifications for security associations.

In one embodiment, the present invention also enables a PE router to establish or delete one or more security associations in response to one or more route advertisements received from BGP peer devices. For example, a PE router may receive a route advertisement from another PE router. The route advertisement may be directed to one or more specific IP-Sec clients. For example, the specific IP-Sec clients may be identified by community values, data sensitivity levels, security policy, and so on. The PE router may then establish or delete security associations for the identified IP-Sec clients in accordance with received one or more route advertisements.

FIG. 4 illustrates a flowchart of a method 400 for establishing or deleting one or more IP-Sec associations based on route advertisements. Method 400 starts in step 405 and proceeds to step 410.

In step 410, method 400 receives an advertisement for an added or deleted route from a peer device. For example, an advertisement for an added route may be received from a BGP peer device.

In step 420, method 400 identifies which IP-Sec client(s) should receive the advertisement. In one embodiment, BGP community values, data sensitivity levels, security policy, etc. may be provided to allow the PE device to identify which IP-Sec clients should receive the route advertisement.

In step 430, method 400 establishes or deletes one or more security associations for the identified IP-Sec clients. For example, if IP-Sec clients with a specific community value are identified in step 420, security associations are established with those IP-Sec clients in accordance with received community values. The method then proceeds to step 410 to continue receiving an advertisement for an added or deleted route.

It should be noted that although not specifically specified, one or more steps of methods 300 and 400 may include a storing, displaying and/or outputting step as required for a particular application. In other words, any data, records, fields, and/or intermediate results discussed in the methods 300 and 400 can be stored, displayed and/or outputted to another device as required for a particular application. Furthermore, steps or blocks in FIG. 3 and FIG. 4 that recite a determining operation, or involve a decision, do not necessarily require that both branches of the determining operation be practiced. In other words, one of the branches of the determining operation can be deemed as an optional step.

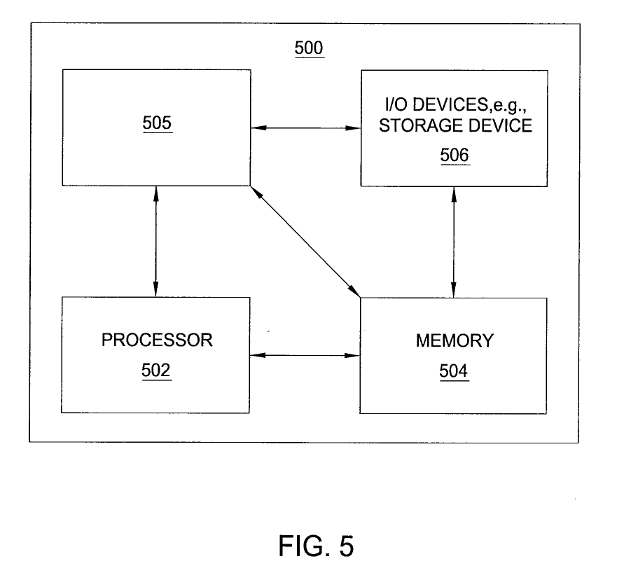

FIG. 5 depicts a high-level block diagram of a general-purpose computer suitable for use in performing the functions described herein. As depicted in FIG. 5, the system 500 comprises a processor element 502 (e.g., a CPU), a memory 504, e.g., random access memory (RAM) and/or read only memory (ROM), a module 505 for providing dynamic route advertisements, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 505 for providing dynamic route advertisements can be loaded into memory 504 and executed by processor 502 to implement the functions as discussed above. As such, the present method 505 for providing dynamic route advertisements (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing dynamic route advertisement, comprising:
receiving a notification for an establishment, a deletion or a modification of a security association for a sub-network;
adding or deleting a route for said sub-network based on said security association; and
dynamically advertising said added or deleted route to one or more peer devices.

2. The method of claim 1, wherein said notification is received from a Small Office Home Office (SOHO) device.

3. The method of claim 2, wherein said SOHO device negotiates said security association for said sub-network.

4. The method of claim 1, wherein said security association is negotiated using a standard protocol.

5. The method of claim 4, wherein said standard protocol comprises an Internet Security Association and Key Management Protocol (ISAKMP).

6. The method of claim 1, further comprising:
receiving an advertisement for an added or deleted route from a peer device;
identifying at least one Internet Protocol-Security (IP-Sec) client for receiving said advertisement; and
establishing or deleting one or more security associations for the at least one identified IP-Sec client.

7. The method of claim 6, wherein said identifying is based on at least one of: a Border Gateway Protocol (BGP) community value, a data sensitivity level, or a security policy.

8. A computer-readable medium having stored thereon a plurality of instructions, the plurality of instructions including instructions which, when executed by a processor, cause the processor to perform the steps of a method for providing dynamic route advertisement, comprising:
receiving a notification for an establishment, a deletion or a modification of a security association for a sub-network;
adding or deleting a route for said sub-network based on said security association; and
dynamically advertising said added or deleted route to one or more peer devices.

9. The computer-readable medium of claim 8, wherein said notification is received from a Small Office Home Office (SOHO) device.

10. The computer-readable medium of claim 9, wherein said SOHO device negotiates said security association for said sub-network.

11. The computer-readable medium of claim 8, wherein said security association is negotiated using a standard protocol.

12. The computer-readable medium of claim 11, wherein said standard protocol comprises an Internet Security Association and Key Management Protocol (ISAKMP).

13. The computer-readable medium of claim 8, further comprising:
receiving an advertisement for an added or deleted route from a peer device;
identifying at least one Internet Protocol-Security (IP-Sec) client for receiving said advertisement; and
establishing or deleting one or more security associations for the at least one identified IP-Sec client.

14. The computer-readable medium of claim 13, wherein said identifying is based on at least one of: a Border Gateway Protocol (BGP) community value, a data sensitivity level, or a security policy.

15. An apparatus for providing dynamic route advertisement, comprising:
means for receiving a notification for an establishment, a deletion or a modification of a security association for a sub-network;
means for adding or deleting a route for said sub-network based on said security association; and
means for dynamically advertising said added or deleted route to one or more peer devices.

16. The apparatus of claim 15, wherein said notification is received from a Small Office Home Office (SOHO) device.

17. The apparatus of claim 16, wherein said SOHO device negotiates said security association for said sub-network.

18. The apparatus of claim 15, wherein said security association is negotiated using a standard protocol.

19. The apparatus of claim 18, wherein said standard protocol comprises an Internet Security Association and Key Management Protocol (ISAKMP).

20. The apparatus of claim 15, further comprising:
means for receiving an advertisement for an added or deleted route from a peer device;
means for identifying at least one Internet Protocol-Security (IP-Sec) client for receiving said advertisement; and
means for establishing or deleting one or more security associations for the at least one identified IP-Sec client.
